(19) United States
(12) Patent Application Publication
(10) Pub. No.: US 2018/0018893 A1
(43) Pub. Date: Jan. 18, 2018

(54) METHOD AND SYSTEM FOR IDENTIFYING MARKED RESPONSE DATA ON A MANUALLY FILLED PAPER FORM

(71) Applicant: PERSERVERANCE IT SOLUTIONS PRIVATE LIMITED, Noida (IN)

(72) Inventors: Mukesh Sharma, Noida (IN); Prashant Dhaka, Ghaziabad (IN); Minesh Upadhyaya, Noida (IN); Chris Morgan, Cincinnati, OH (US)

(73) Assignee: PERSERVERANCE IT SOLUTIONS PRIVATE LIMITED, Noida (IN)

(21) Appl. No.: 15/655,641

(22) Filed: Jul. 20, 2017

(30) Foreign Application Priority Data
Jul. 17, 2016 (IN) 201611024430

(51) Int. Cl. G09B 7/06; G06F 17/24; G06F 17/21; G09B 5/02

(52) U.S. Cl. CPC G09B 7/06; G09B 5/02; G06F 17/248; G06F 17/212; G06F 17/217; G06F 17/243

(57) ABSTRACT

An apparatuses, systems, computer program products, and methods are disclosed for discovering, evaluating and storing data related to marked response area on manually filled paper forms, the method comprising steps of capturing one or more digital image of a data filled physical paper forms or automated generated paper form with filled in data, fixing the perspective of the captured data filled paper form digital image, identifying the form regions in the data filled paper forms' digital image, obtaining the metadata of the captured data filled paper form digital image, fetching relevant form data from one or more databases and servers, and adjusting the response area co-ordinates on the image and process each response on the image to identify if it is marked or not.

### CROSS-REFERENCES TO RELATED APPLICATIONS

This application claims the benefit of Indian Patent Application Number 201611024430 entitled “A METHOD AND SYSTEM FOR IDENTIFYING MARKED RESPONSE DATA ON A MANUALLY FILLED PAPER FORM” and filed on Jul. 17, 2016, for Mukesh Sharma, which is incorporated herein by reference in its entirety for all purposes.

### FIELD

The present invention generally relates to a method and system for processing data, specifically, the invention provides a method and system for identifying manually marked response areas in paper forms.

### BACKGROUND

In many situations, people are provided with a physical form filled with questionnaires and with one or more answers to choose from for the provided questionnaire. The people then mark a tick or darken each area to indicate their answer. These answers are typically manually checked by an expert for correctness and responses are logged in some way for answer(s) marked by each test taker. This is a time-consuming and error-prone manual process.

Recently, an overhead projector (OHP) transparent sheet answering method was introduced to record inputs or answers of users. OHP sheets contain only multiple choice answer marking areas on which a user can mark their answers. Multiple choice questions are provided on a plain white paper and a user is required to place an OHP transparent sheet exactly over the question paper and mark relative correct answers matching the co-ordinates on the OHP sheet with the questions on the plain white paper. Once filled-in or answered, these OHP sheets are fed to a machine which analyses dark spots for recognizing the correct answers and their relative scores are then provided. This methodology is error-prone and complicated as a user must exactly place the OHP sheet over the white paper on which questionnaires are printed. If the user marks correct answers' slightly deviating from the exact coordinates on the original sheet, these answers are not counted or considered as null and void.

In another patent application, a method, system, and computer program product for evaluating images of handwritten documents with handwritten symbols is disclosed. A set of symbols from an image is determined by sequentially applying a series of predefined techniques. The symbols derived from the image are then compared to a set of predefined symbols. If the set of symbols determined by applying the predefined technique do not match with a predefined set of symbols, a second predefined technique is applied to determine the set of symbols from the image. If either of the predetermined techniques is successful in determining the set of symbols, an evaluation report is created. This existing technique or process is also time consuming and does not provide an option to evaluate manually created answer sheets quickly in case the answer is answered by a process of selecting one option amongst the available choices.

In another patent, a system and method for creating and grading handwritten tests is provided. The tests are input into a computer wherein the answers are recognized with a character recognition program and then compared to a list of possible answers. The system then automatically provides a grade for each answer and to each test. In this invention, the test is distributed to the test takers on a paper form. The test takers input one or more responses to the one or more test questions in the one or more response regions. The tests are collected and scanned into a computer where response inputs from test takers are converted into an electronic format. The responses are analyzed by intelligent character recognition and reviewed, wherein responses are compared to acceptable answers for each region. The tests are graded based on the number of responses deemed to be substantially similar to the one or more acceptable answers to a respective question. If the handwritten response in a question region matches the one or more acceptable correct responses, credit is assigned to the test taker. Also, this invention provides a method to manually review and evaluate the actual handwritten responses provided by the test takers, such that the test grader may allow for full or partial credit. Such manual review and evaluation may be performed via a graphical display, e.g., computer monitor, of the one or more test takers' handwritten responses. But this process does not account for pre-existing paper forms or questionnaires which contain multiple choice options. The solution also requires a large bank of acceptable responses.

In yet another patent, a system for automatically reading a response form using a digital camera is provided. In this solution, structured forms which contain distinct rows and columns of response areas are dynamically generated by a computer program. End users mark response areas within these distinct rows and columns on the structured forms. The solution then enables end users to capture an image of the completed forms with a digital camera and submit to a computer program. The computer program than uses an algorithm to navigate the digital image, define the distinct row and column area in which answers will be presented, and determine which of the possible answers were marked by the user. This solution requires the end user to correlate between a questionnaire that contains questions and a structured answer sheet with distinct rows and columns for answer input. Answers cannot be combined with questions or be placed in a format other than distinct rows or columns. Answers must be provided on forms created by the solution and cannot be provided on forms created outside the solution. Forms can only be one page. The digital image must be taken by a camera containing the software that is part of the solution. This solution is, therefore, limited in application.

In view of the foregoing, there is a need to provide a method and system for discovering, storing and evaluating marked response areas on manually filled structured and unstructured paper forms.

### SUMMARY

One objective of the Invention herein is to provide a method and system for discovering, storing and evaluating marked response data on manually filled paper forms.

In accordance with one embodiment, a method for processing a marked area on a manually filled paper form is disclosed. The method includes the steps of providing an image of a structured or unstructured form that has been manually filled by a user; identifying one or more form areas in the form image, the form areas including one or more questions areas and response areas; discerning metadata from the identified form areas on the form image; fetching relevant form data from one or more databases based on the metadata found in the form image; modifying one or more coordinates based on one or more corrections required to be made to the orientation of the form image; and processing each response for each response area on the form digital image to identify if it is marked or not.

In accordance with another embodiment, a method of generating a digital form and corresponding metadata for a pre-existing paper form is disclosed. This method enables users to identify areas on a pre-existing form within which an end-user may provide responses. More specifically, the method includes displaying an image of the pre-existing form on a user interface screen. The user then draws rectangles overlaying the areas on the digital image of the form in which end users may provide responses. In doing so, the method can derive the X and Y coordinates of those areas relative to the edges of the form. In addition to the X and Y coordinates for response areas, the user provides other metadata, such as the form name, the page number (if the form has multiple pages), the organization to whom the form relates and other metadata that may be necessary for identifying and cataloging the form image in a database.

In accordance with yet another embodiment, a method for generating one or more physical paper forms is disclosed. The method includes providing a user with one or more dynamic templates that determine the layout of one or more question areas and response areas on a form; receiving metadata from the user; storing the metadata on a data storage means; generating a form from the metadata which contains at least the one or more question areas and response areas; and providing a bar-code that contains metadata for each potential user who is expected to submit an answer on each page for machine-reading.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 represents an exemplary environment which practices the teachings of the present disclosure.

FIG. 2 represents various modules of a response area identification system in accordance with an embodiment of the present disclosure.

FIG. 3a represents an automatically generated response form containing one or more response areas and borders of a page, according to an embodiment herein.

FIG. 3b represents a customized user created form with user marked co-ordinates in the form to identify question and response areas in accordance with an embodiment of the present disclosure.

FIG. 3c represents adjusted page border co-ordinates and recognized form areas on a scanned paper form, according to an embodiment herein.

FIG. 4 represents a flow diagram for processing an unstructured form in accordance with an embodiment of the present disclosure.

FIG. 5 represents a flow diagram for processing an unstructured form in accordance with another embodiment of the present disclosure.

FIG. 6 represents a flow diagram for generating a structured form in accordance with an embodiment of the present disclosure.

FIG. 7 represents a flow diagram for reading a manually filled paper form in accordance with an embodiment of the present disclosure.

### DETAILED DESCRIPTION

The present invention provides a method for identifying manually marked response areas in unstructured forms. Embodiments of the present invention will now be described in detail with reference to the accompanying drawings, in which some, but not all, embodiments of the invention are shown. Indeed, the invention may be embodied in many different forms and should not be construed as limited to the embodiments set forth herein. Rather, these embodiments are provided so that this disclosure will satisfy applicable legal requirements.

Applications, software programs or computer readable instructions may be referred to as components or modules. Applications may be hardwired or hard coded in hardware or take the form of software executing on a general purpose computer, such that, when the software is loaded into and/or executed by the computer, the computer becomes an apparatus for practicing the invention, or they are available via a web service. Applications may also be downloaded in whole or in part through the use of a software development kit or a toolkit that enables the creation and implementation of the present invention. In this specification, these implementations, or any other form that the invention may take, may be referred to as techniques. In general, the order of the steps of the disclosed processes may be altered within the scope of the invention.

In the forgoing description, reference to the following terms is made. A “structured form” is a form that is generated by a response area identification system and has a pre-defined layout with fields positioned at pre-defined places on a page. In case the form is a multi-page form, the fields are positioned at exactly the same place on each page of the multi-page form. The layout of a structured form may be user-defined or software configured. An “unstructured form” is a form that is not structured or is not generated by the response area identification system.

The “total form area” of a form is an area of a page which is to be processed by the response area identification system. A “question area” is a sub-part of the total form area in which one or more questions are provided. A user may provide his/her response in corresponding response area within the question area. A “response area” is a sub-part of the question area in which a user may provide his/her responses. In particular, the response area may be at least one small region which allows the user to darken by writing over the small region to indicate his answer for the corresponding question. A “marked area” is the sub-part of the response area that is determined by the system to have been marked by the end user.

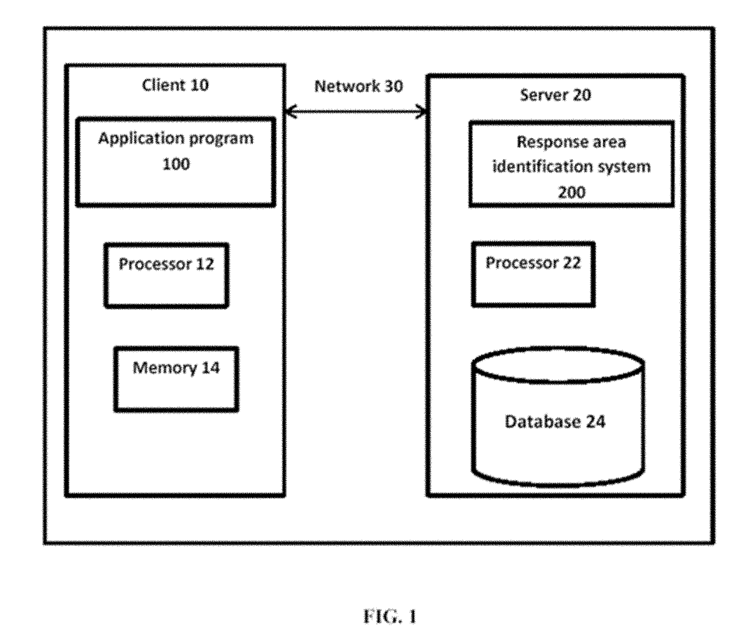

Referring now to the drawings, FIG. 1 is a system configured as client/server architecture used in an embodiment of the present disclosure. A “client device” is a member of a class or group that uses the services of another class or group to which it is not related. In the context of a computer network, such as the Internet, a client device is a process (i.e. roughly a program or task) that requests a service which is provided by another process, known as a server program. The client device process uses the requested service without having to know any working details about the server program or the server itself. In networked systems, a client device process usually runs on a computer that accesses shared network resources provided by another computer running a corresponding server process.

A “server” is typically a remote computer system that is accessible over a communication medium such as the Internet. The client device process may be active on a portable device which communicates with the server process via a network that allows multiple client devices to take advantage of the information-gathering capabilities of the server. Thus, the server essentially acts as an information provider for a computer network.

In FIG. 1, the system for practicing the teachings of the present disclosure includes one or more client devices (10), one or more servers (20), one or more databases (22, 24) and a network (30) which is used for establishing communication between the client device (10) and the server (20). The client device (10) includes an application program (100), a processor (12) and a memory (14). In an embodiment, the application program 100 is configured to correspond with a response area identification system 200 via the network 30. The application program 100 is provided with a user interface via which a user provides the inputs as required by the system 200. For example, a user captures and uploads an image of a paper form (for example, a structured form or an unstructured form) to the server 20 using the application program 100. In accordance with an alternate embodiment, the client device 10 may access the response area identification system 200 via a website. It should be noted that other alternate techniques of accessing the response area identification system 200 via the client device 10 are possible and are included within the teachings of the present disclosure.

In one embodiment, the processor 12 in the client device 10 executes the application program while the memory 14 stores the data such as a form image, form coordinates, etc. which is then uploaded to the server. Further, the client device 10 may include without limitation a personal computer, laptop, notebook, handheld computer, set-top box, personal digital assistant (PDA), mobile phone and the like.

The server 20 may be a heterogeneous server or any other kind of server known in the art and includes a response area identification system 200, a processor 22 and one or more databases 24. The response area identification system 200 at the server 20 includes various modules used for identifying one or more form regions (for example, question area, response area, etc.) and/or one or more marked areas in response areas of the paper forms. The response area refers to an area wherein the user would provide an answer to a question while a marked area refers to an area (for example, response area) which is marked by the user for indicating his/her answer to a question. The user may mark the marked area either digitally or darken by writing over it in order to identify the appropriate answer.

In one embodiment, the processor 22 controls and collaborates the functioning of all the modules and fetches the required data from the database 24. The database 24 may be a heterogeneous database or any other kind of database known in the art and may store metadata of structured and/or unstructured forms. The metadata may contain form name, page number, unique form identifier, questions, question text, question possible answers, correct answers, coordinates of question area and response area, etc. The database may also store user specific information such as organization name to which the form belongs, unique identifier of a user who filled the form, unique identifier of the organization with whom the form and the user are registered, etc. Additionally, the database 24 catalogs responses provided by the user in the marked areas. In various embodiments, the database 24 may be embedded in the server 20 or it may be maintained by a third-party service provider external to the server 20.

The network 30 is used for establishing communication between the client device 10 and the server 20. The network 30 may be a global area network (GAN), such as the Internet, a wide area network (WAN), a local area network (LAN), or any other type of network or combination of networks. The communication medium may provide for wireline, wireless, or a combination of wireline and wireless communication between devices in the network. In some embodiments of the invention the communication medium described herein may be a cloud computing network.

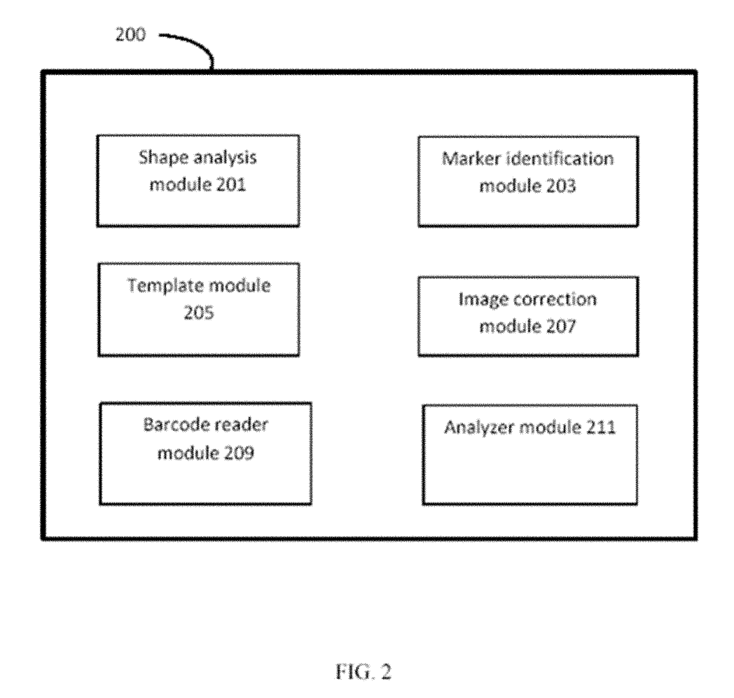

FIG. 2 shows the response area identification system 200 consisting of various modules used for processing of manually filled paper forms. Processing includes discovering, evaluating and storing marked response data on a manually filled paper form. Paper forms may be structured forms or unstructured forms. Not all modules may be necessary in all situations. Further, it is possible that the teachings of two or more of the defined modules may be combined.

The modules include without limitation a shape analysis module 201, a marker identification module 203, a template module 205, an image correction module 207, a barcode reader module 209 and an analyzer module 211. Other modules as required may be added and disclosure is not restricted to the modules mentioned above. A detailed description of each is as follows:

The shape analysis module 201 uses one or more methodologies such as machine vision, to identify a border drawn on an unstructured form or to identify a physical border board placed around or behind the paper form by the end user. This border defines the “total form area”. The shape analysis module 201 also identifies X and Y coordinates of one or more of question areas and/or response areas.

The marker identification module 203 identifies marked area(s) present inside a response area(s). The module 203 examines the percentage of dark pixels present inside the response area. If a response area has dark pixels exceeding a given threshold of the response area (for example, sixty percent), the response area is considered to be a marked area.

Optionally and additionally, the template module 205 dynamically generates structured forms using one or more pre-stored templates based on metadata provided by a user. The metadata may be form name, total number of questions, question texts, question possible answers, correct answers etc. Using the inputs provided, the template module 205 generates a structured form dynamically containing questions, possible answers, their response areas and/or page number. The template module 205 may use one or more templates to determine the layout of questions and possible answers on the structured form. These templates may vary dramatically in format, but allow dynamic number of questions and potential answers across multiple pages. The structured forms generated from these templates may be later used while taking prints.

The image correction module 207 corrects a digital form image orientation by determining an angular deviation between a capturing device (namely, client device) and the paper form image. The image correction module 207 tries to minimize the angular deviation of the form image to be as close to 90 degrees between a capturing device (namely, client device) and the paper form image. The image correction module 207 then adjusts the coordinates of each response area based on the corrected angle or angular deviation. Further, the image correction module 207 may increase or decrease the contrast or brightness or other tones of the image so that the light and the darker pixels are more pronounced.

Optionally and additionally, the barcode reader module 209 is configured to transcode a barcode provided in a structured form by using a traditional means such as Universal Product Code. These barcodes are coded with metadata and/or user-specific information pertaining to the structured form. For example, the barcode reader module 209 identifies a unique form identifier, a unique user identifier, a unique identifier for the organization with which the user and the form are associated, page number of the form, etc. The above information may be used for identifying relevant form data from the database 24 such as questions, relevant answers etc. In an alternate embodiment, the barcode reader module 209 also creates barcode for the structured forms which are generated dynamically by the response area identification system 200. The barcode thus created may have metadata information.

Optionally and additionally, the analyzer module 211 analyzes the marked responses presented in manually filled paper forms submitted to the server 20. The analyzer module 211 aggregates all the marked responses of all the users. The analysis may then be provided on the aggregated data such as number of user who cleared a given set of questions, number of users who incorrectly attempted a question, etc.

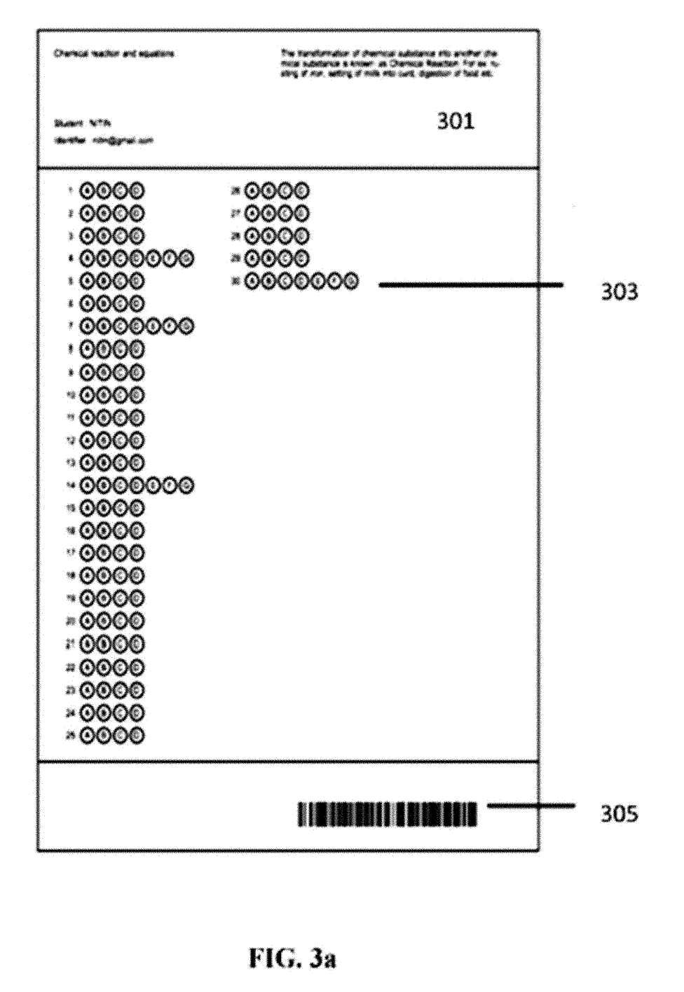

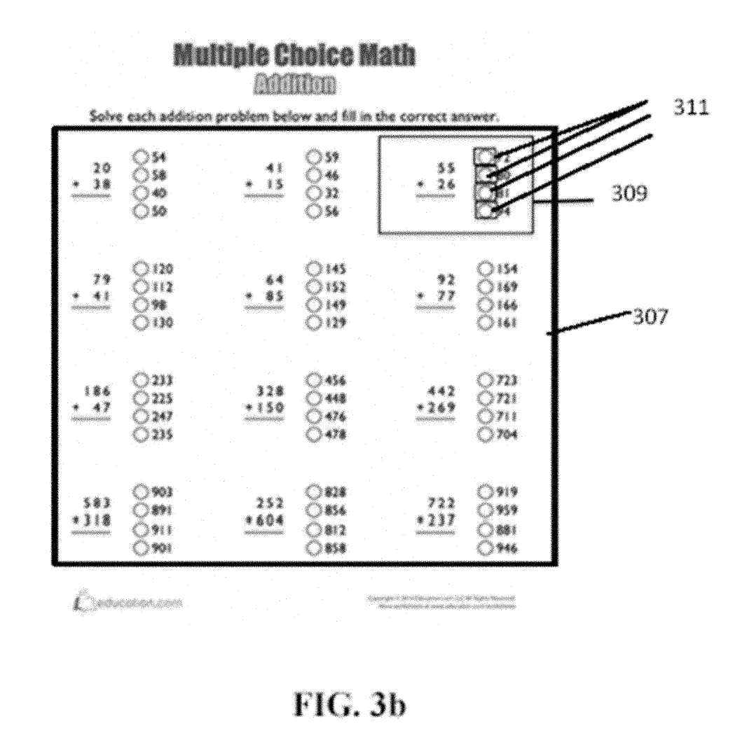

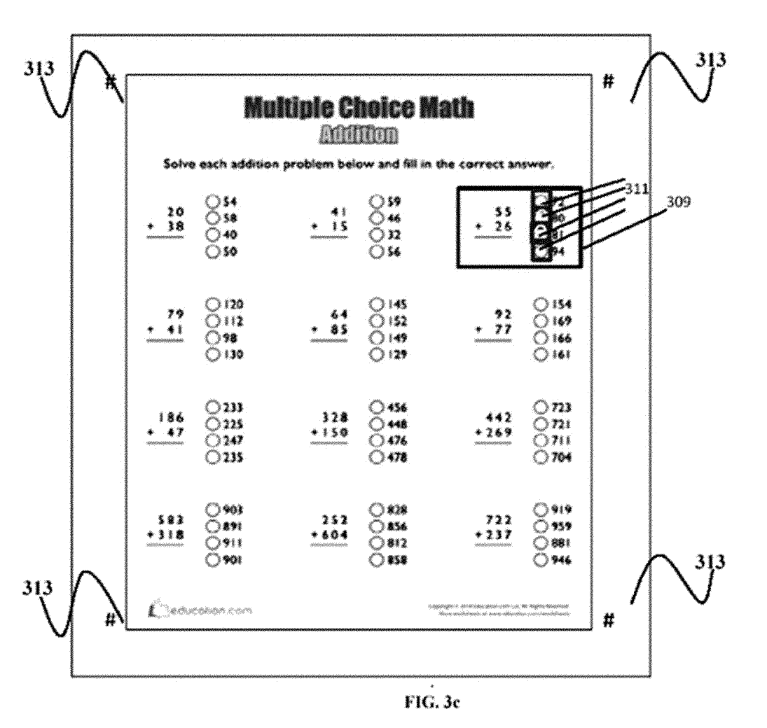

FIG. 3a is an exemplary depiction of a structured form. The structured form 300 includes a header portion 301, a response area 303 and a barcode 305 The header portion 301 is optional. The response area 303 as depicted includes response areas such that each response area has bubbles arranged in a defined layout provided by the response area identification system 200. Defined layout includes defined margins, bubble size, spacing between bubbles, etc. Response areas may be presented in formats other than rows and columns or bubbles. The barcode 305 may contain metadata and/or user-specific information. The structured form as depicted may be created by using templates pre-stored in the response area identification system 200.

FIG. 3b shows an exemplary unstructured form wherein the total form area including one or more response areas/question areas are not predefined or are created outside the system. For the unstructured forms to be processed by the system 200, it is necessary that a border is provided around a form image. This enables the system 200 to identify the total form area of the form image and orient the question areas and/or response areas to this total form area. In an embodiment, a user may draw a border around a form image displayed on the user interface of the application program 100. In this depiction, 307 is the border identified by the user, 309 is the question area and 311 are the response areas. Though only one question area and corresponding response areas are numbered, other question areas/response areas on the form can be similarly identified.

FIG. 3c shows alternate depiction of unstructured form and physical board. A user may place a completed (or manually filled) form within/on a physical board 313 before capturing a digital image of the form 315. The physical board 313 thus defines the total form area to be captured in the form image. Further, 309 is the question area and 311 are the response areas.

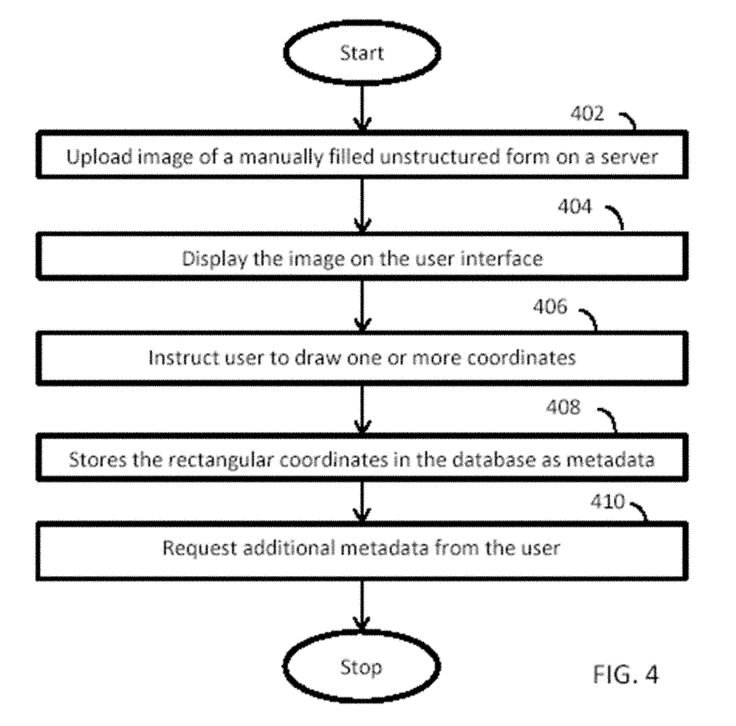

FIG. 4 shows a flow diagram for processing an unstructured form in accordance with an embodiment of the present disclosure. At step 402, an image of a manually filled unstructured paper form is uploaded on the server. This may be done once the image is captured by a user via any of an image acquiring/capturing device such as a camera, a scanner, etc. The captured image may be saved in the memory of the user device and using the application program, it is uploaded to the server 20.

At step 404, the shape analysis module of the system 200 may display the uploaded image in a user interface of the application program 100 due to absence of defined total form area, question areas and response areas. At step 406, the user may be instructed to indicate the border of the form by drawing one or more indicators over one or more response areas and/or question areas in the displayed form image. The user may draw a border digitally on the form image to indicate the total form area and also indicate the one or more response areas and/or question areas by way of drawing an indicator, for example a rectangle, circle, etc. FIG. 3b shows the image of the unstructured form on which rectangular indicators are provided around the total form area, question areas and possible response areas. The shapes can be drawn by using without limitation a digital pen or stylus or finger touch, etc. Further, the user may be requested to provide coordinates of the indicated question area and response areas to correctly orient the respective areas on a form image.

At step 408, the coordinates of the indicated response areas and/or question areas are stored in the database 24. At step 410, the user is instructed to input additional metadata by using the user interface. The additional metadata may be a unique identifier, organization identifier, page number of the form, coordinates of question area and coordinates of response area etc. This data is also stored in the database 24. In an embodiment, the database 24 may maintain a lookup table containing mappings of a unique user identifier and corresponding metadata and/or user-specific information.

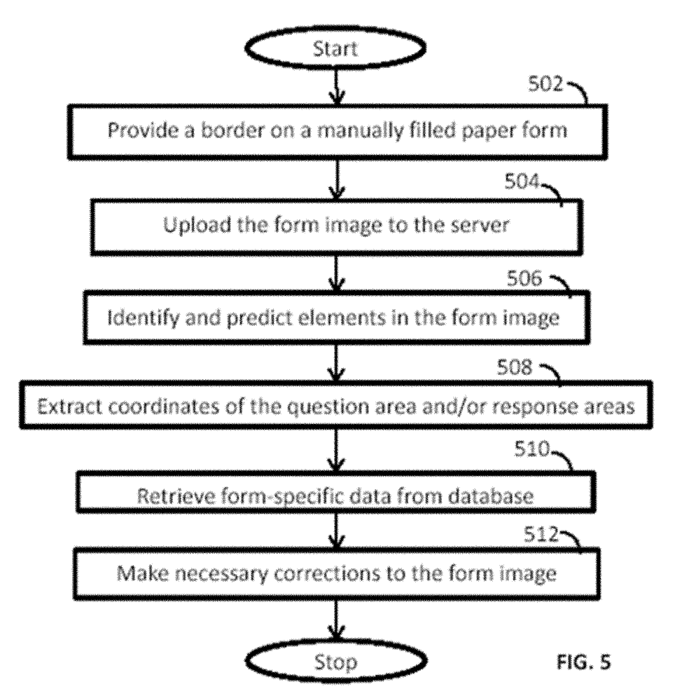

FIG. 5 shows a flow diagram for processing an unstructured form in accordance with another embodiment of the present disclosure. At step 502, a border is provided on a manually filled paper form not generated by system 200. For this, the form is placed within a physical board by a user to define a border of the form which in turn defines the total form area. Optionally, the user may also mark the total form area using the physical board before capturing a form image. Further, the user is required to mark one or more question areas as well as response areas in the paper form.

At step 504, an image of the manually filled paper form with border, question areas as well as response areas is uploaded on the server. For example, a user may capture an image of the form using an acquiring/capturing device such as a camera, a scanner, etc. and using the application program, uploads it on the server 20. Optionally, the captured image may be saved in the memory of the user device.

At step 506, the shape analysis module 201 uses a technique for example, machine vision to identify and predict elements such as but not limited to Universal Product Code (UPC) or quick response (QR) code border region of the form. The coordinates of the question areas as well as response areas are then identified based on total form area of the form i.e. border region in the image. At step 508, the metadata derived by the processor (22) from the barcode on structured forms is used to fetch question area and/or response area coordinates from the database (24). Optionally, when processing an unstructured form, the user may be requested to provide metadata such as the organization to whom the form relates, and the unique form ID. Once the necessary metadata is extracted from the barcode on structured forms or provided by the end user on unstructured forms, it is used as an input to the database (24) to authenticate the form and account and thereby, retrieve more form-specific data necessary to decipher the other parts of the form at step 510. In an embodiment, a query is formulated by the processor 22 using the extracted metadata. The query may contain for example, question identification key and/or X and Y coordinates relative to a border in which the distinct question is located, answer identification key within each distinct question, the X and Y coordinates relative to a border in which the distinct answer options is located, etc. Further, the query may ask for a correct answer for each question provided in the form. This query is then used to fetch relevant data from the database (24).

At step 512, necessary corrections are made to each response area and/or question area coordinates of the form image. The image correction module 207 recalculates the X and Y coordinates of the response area of the form image based upon corresponding coordinates retrieved from the database. The image correction module 207 then aligns the image such that the X co-ordinates and the Y co-ordinates of the regions in the image are in co-ordination with the corresponding X co-ordinates and the Y-co-ordinates retrieved from the database.

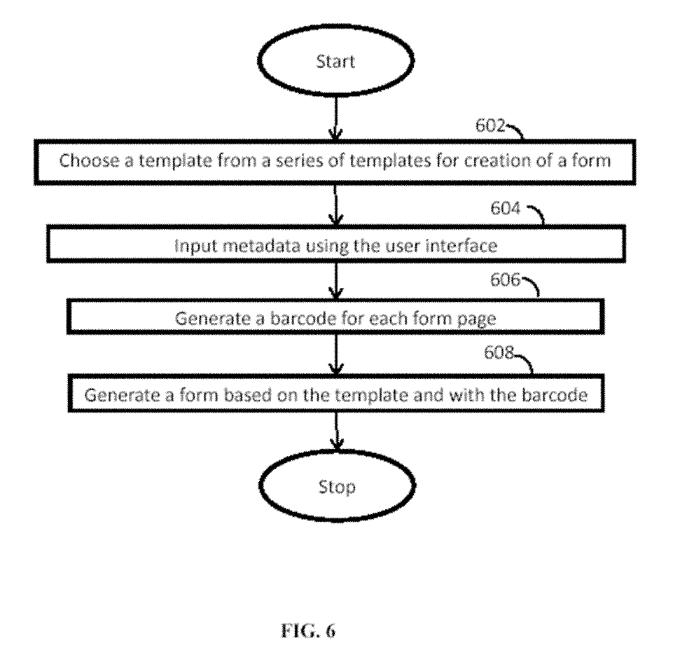

FIG. 6 depicts a flow diagram for generation of one or more structured forms in accordance with one embodiment. At step 602, the template module 205 receives a request for selection of a template from a series of pre-stored templates for creation of a structured form. The template module 205 may fetch the templates from the database 24 and present it to a user interface for user selection.

After a template is selected, at step 604, metadata is received through the user interface such as a unique identifier (form name), total number of questions, question text, number of answer options, correct answer, etc. This metadata is stored in the database 24 which is then used for generation of the structured form. At step 606, the barcode reader module 209 generates a barcode for each structured form page containing information such as unique user identifier, unique form identifier, page number, unique organization identifier, etc. At step 608, the barcode is placed in the selected template at, for example, the bottom of the template page. In case there are multiple pages, a barcode may be generated for each page and placed at the bottom of the corresponding page. Thus, the structured form is generated containing response area(s), question area(s), page number, barcode, etc.

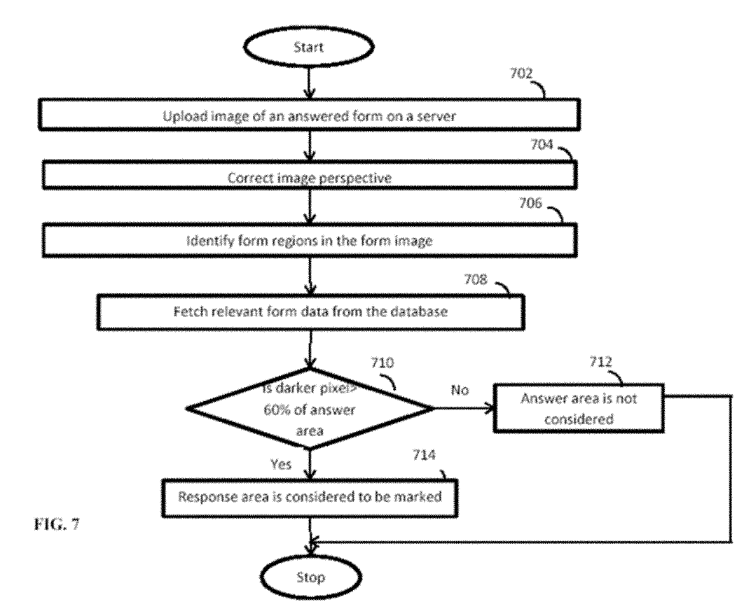

FIG. 7 shows a flow diagram relating to reading a manually filled paper form. At step 702, an image of a manually filled paper form is received by the server. The image of the manually filled paper form may be received by the server once the form image is captured by a user via an image acquiring device such as a camera, a scanner, etc. and uploaded on the server using the application program. At step 704, the orientation of the image is corrected. For this, the image correction module fixes the perspective between the image capturing device and the form as close to 90 degrees as possible. Further, the image correction module may automatically modify the coordinates of the response area based on the corrections made in step 704. In an alternate embodiment, the image correction module 207 may increase the contrast of the image so that the light and the dark pixels are better identified.

At step 706, form regions in the form image are identified. In case the form is a structured form, the barcode reader module 209, identifies and reads the barcode in the form image to identify form regions. However, if the form is an unstructured form, either the user manually identifies the form regions or due to the use of the physical board, form regions are identified relative to the border defined by the board as explained above. At step 708, relevant data is fetched from the database. In case of a structured form, a series of unique identifiers present in the barcode are extracted and using the lookup table of the database, data relating to number of questions, question text, possible answer choices, correct answers, X and Y coordinates for response areas etc. are fetched. In case of an unstructured form, using the metadata provided by the user, unique identifier of the organization to which the user is associated and the unique form that is to be reviewed is deciphered. Thereafter, using the lookup table from the database, data relating to number of questions, question text, possible answer choices, correct answers, X and Y coordinates of response areas, etc. relating to a form of the organization are fetched.

At step 710, the marker identification module identifies if a response area has been marked by the user. For this, the marker identification module 203 calculates the percentage of dark pixels in each response area of the form image. The marker identification module 203 then determines if the dark pixels cover more than a given percentage of the response area. If the dark pixels do not cover the given percentage of the response area, then the system considers the response area as not marked at step 712 and repeats step 710 for each response area. Else the system considers the response area to be a marked area at step 714 and repeats step 710 for each response area.

Based upon whether a response area is marked or not, the system 200 may conduct one or more analysis. For example, if a response area is marked, the system may evaluate it to be a correct answer and accordingly award marks/points to the user and store the same in the database 24.

The invention finds varied applications. For example, a user may be asked to identify a portion of anatomy on a diagram by marking that area (response area). In another instance, the user may be asked to mark an area of a rubric that is formatted in such a way that the user can read the rubric criteria. In another scenario, the user may be asked to match term(s) to diagram areas by drawing a line connecting the term(s) and the diagram area(s). Further, the user may be asked to document a multi-step problem and provide the results of their work for each step in a given area. Or in other case, the user may be asked to circle one or more of a series of images or terms that relate to a question. Thus the present disclosure allows the users to capture the image of the document. The image is then loaded and stored into one or more databases. The present method and system automatically identifies the response areas and determines if an appropriate mark has been made by the user. The responses are stored in the database, which may be later used for performing analytics on multiple submissions.

It will be apparent to one of the ordinary skill in the art that aspects of the disclosure, as described above, may be implemented in many different forms of software, firmware, and hardware in various implementations. The actual software code or specialized control hardware used to implement aspects consistent with the present disclosure is not limiting of the present disclosure. Thus, the operation and behavior of the aspects were described without reference to the specific software code it being understood that a person of ordinary skill in the art would be able to design software and control hardware to implement the aspects based on the description herein.

With the above embodiments in mind, it should be understood that the embodiments might employ various computer-implemented operations involving data stored in computer systems. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a computer readable medium. The computer readable medium is any data storage device that can store data, which can be thereafter read by a computer system. Examples of the computer readable medium include solid state drives, hard drives, SD cards, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

No element, act, or instruction used in the description of the present disclosure should be construed as critical or essential to the invention unless explicitly described as such. Also, as used herein, the article “a” is intended to include one or more items. Where only one item is intended, the term “one” or similar language is used.

What is claimed is:

1. A method for processing a marked area on a manually filled paper form, the method comprising:
identifying a border within an image of the manually filled paper form to determine total form area;
identifying one or more form regions in the form image, the form regions including one or more questions areas and response areas;
discerning metadata from the identified form regions on the form image;
fetching relevant form data from one or more databases based on the metadata of the form image;
modifying one or more coordinates of the form regions based on one or more corrections required to be made to the orientation of the form image; and
processing each response of each response area of the response areas on the form image to identify if it is marked or not.

2. The method of claim 1 wherein the identifying one or more form regions comprises identifying the co-ordinates of each of the form regions in the form image.

3. The method of claim 1 wherein the identifying one or more form regions comprises identifying the one or more form regions by shape analysis.

4. The method of claim 1, wherein the modifying comprises aligning the form image such that X coordinates and Y coordinates of the response area of the form image are in coordination with X coordinates and Y-coordinates of the response area retrieved from a database for the form.

5. The method of claim 1 wherein the processing comprises:
determining if a mark has been made by an user by calculating the percentage of dark pixels within the each response area;
calculating if the response area has dark pixels exceeding a threshold of the response area, the response area is considered to be marked by user; and
storing the response area as a marked area in the database.

6. The method of claim 1 further comprising fixing a perspective of the form image, the fixing comprises:
correcting an angle of the form image to be as close to 90 degrees between a capturing device and the manually filled paper form; and
adjusting the coordinates of each response area based on the corrected angle.

7. The method of claim 1 further comprising adjusting contrast of the form image, the adjusting comprising:
increasing the contrast of the image so that light and darker pixels are more pronounced.

8. The method of claim 1 wherein the metadata comprises one or more of a unique form identifier, a page number of the form image, coordinates of the response areas and question areas on the form.

9. A method of generating a digital form and corresponding metadata for a pre-stored paper form, the method comprising:
displaying an image of the pre-stored paper form that has been manually filled by an user on a user interface screen;
receiving inputs from the user with respect to one or more question areas and response areas on the form image, the inputs include at least one of drawing of an indicator on the one or more question areas and response areas, or coordinates of each question area on the form image along with the coordinates of each response area within each question area on the form image;
receiving additional metadata from the user; and
storing the received inputs and the additional metadata in a database.

10. The method of claim 9 further comprising deriving X and Y coordinates of the one or more indicated question areas and response areas relative to the edges of the digital form.

11. The method of claim 9 wherein the metadata comprises one or more of a unique identifier of the form image, a unique identifier of the organization, and a page number of the form image.

12. A method for generating one or more physical paper forms, the method comprising:
providing an user with one or more dynamic templates that determine the layout of one or more question areas and response areas on a form;
receiving metadata from the user;
storing the metadata in a database;
generating a form from the metadata which contains at least the one or more question areas and response areas; and
providing a bar-code on each page for machine-reading that contains user-specific information.

13. The method of claim 12 wherein the metadata comprises form name, total number of questions, question texts, possible answers of each question, and correct answers.

14. The method of claim 12 wherein the user-specific information comprises unique identifier of the person who is to fill out the form, a unique identifier of the form image, a page number of one or more forms and a unique identifier of the organization with whom the form and user are registered.

15. A method for capturing images of paper forms that have been developed outside of a response area identification system to determine if marks have been made by an user within specific coordinates, the method including:
placing a manually filled paper form within a physical board on which a border has been pre-drawn to identify total form area of the completed paper form;
orienting one or more question areas and/or response areas to this total form area; and
capturing one or more images of the data filled physical paper forms.
